(19) United States
(12) Patent Application Publication
(10) Pub. No.: US 2023/0400588 A1
(43) Pub. Date: Dec. 14, 2023

(54) Vehicle and method for avoiding collision of a vehicle with an obstacle

(71) Applicants: Kinotex Sensor GmbH, Igel (DE); BASF SE, Ludwigshafen (DE)

(72) Inventors: Winfried Bindges, Igel (DE); Roland Senninger, Ludwigshafen (DE)

(21) Appl. No.: 18/035,416

(22) PCT Filed: Nov. 5, 2021
(86) PCT No.: PCT/DE2021/100883

§ 371 Date: May 4, 2023

(30) Foreign Application Priority Data
Nov. 5, 2020 (DE) 102020129233.3

(51) Int. Cl. G01S 17/931

(52) U.S. Cl. CPC G01S 17/931

(57) ABSTRACT

A vehicle (10) is proposed which has one or more optical sensor elements (20, 21, 22, 23) in the region of a first side, in particular its front side (11), which, in interaction with an evaluation and control electronics (30, 40) provided on board or positioned fully or partly remotely to said vehicle (10), is/are configured to warn about a collision of said driving vehicle (10) with an obstacle, to avoid the obstacle or the stop said vehicle (10) when an obstacle is being detected. To this end, at least one, several or all of the optical sensor elements (20, 21, 22, 23) has/have a field of view (50, 51, 52, 53) with a horizontal and/or vertical viewing angle range (α, α′) of less than 3 degrees. Further, a method for avoiding collision of a vehicle (10) with an obstacle is proposed.

The invention relates to a vehicle with a sensor system as well as to a method configured to warn a vehicle, in particular a driver-less one, operated without any human intervention and/or automatically controlled, in particular lane-bound, about a collision of the driving vehicle with an obstacle, to avoid the obstacle, to stop the vehicle when an obstacle is being detected and/or to issue a warning to a control center.

### PRIOR ART

From DE 10 2018 110 852 A1, there is known a device for securing a machine or automatically controlled movable device, in particular a handling device such as a robot or an AGV (“automated guided vehicle”). This document provides for a safety sensor system for detecting objects in a working space, at distance from, or in an environment of the device. The safety sensor system comprises a tactile sensor system and a proximity sensor system, wherein the sensors used are based on optical measurement principles.

From DE 10 2014 206 473 A1, there is known a method providing automated assistance to a driver of a lane-bound vehicle. To this end, a camera is provided at the front side of the vehicle both on the left and the right-hand side which detect a clearance in front of the vehicle and which interact with an evaluation unit to warn about an imminent collision.

From DE 10 2004 041 821 A1, there is known a touch-less safety system using ultrasound or microwave sensors for securing a machine-controlled handling device. There, the proximity sensors used can be ultrasound or microwave sensors. Further, it is described that the ultrasound or microwave sensors may be combined with another sensor which operates based on a different physical principle.

Another touch-less safety system for securing a machine-controlled handling device is known from DE 10 2013 021 387 A1. The system operates based on a capacitive sensor system.

### SUMMARY AND ADVANTAGES OF THE INVENTION

The invention relates to a vehicle according to claim 1 and to a method according to claim 15.

The dependent claims relate to preferred embodiments of the invention.

Compared to the prior art, the vehicle having the inventive sensor system and the inventive method offer the advantage that comparatively small obstacles such as pipelines, obstacles with different cross-sections and degrees of reflection, dangling power cables, bundles of pipes, corner lights, cable looms, thin posts etc. projecting into the driveway of the vehicle can be well and reliably detected, even when the conditions are bad such as when there is oncoming light or the sun is blinding, when there is smoke or fog or when measurements are taken at an oblique angle downwards.

Moreover, sensitivity of the detection as well as minimum distance for the warning thresholds of the warning system may easily be adjusted via the provided evaluation and control electronics.

Now, the driving speed of the vehicle can automatically be either reduced or the vehicle will be stopped immediately and/or a control center will be informed.

Furthermore, with sensors provided in the region of the corners of the vehicle, it is not only possible to monitor the region in front of the vehicle but also a region sideways of the vehicle. This may be achieved with additional sensors as well.

By providing at least two sensors located in spatial proximity to each other, the signals or measured values of a sensor can be validated, and plausibility checked, respectively, using the signals or measured values from the other sensor. Thereby, reliability of detection is increased, and false alarms are avoided.

In this respect, it is particularly advantageous that the two sensors located in spatial proximity to each other are arranged in particular perpendicularly to the direction of travel and in parallel to the ground offset from each other and operate at different wavelength ranges, or when the maximum sensitivity of both sensors is at a different wavelength.

Furthermore, it is advantageous to combine sensors located in spatial proximity to each other which operate based on the principle of travel-time measurement.

Another advantageous configuration is to combine sensors which operate based on the principle of travel-time measurement with sensors which operate based on the phase-comparison method.

When using sensors which operate based on the principle of travel-time measurement, it is advantageous that they ensure a resolution of at least 2×2 pixels. By combining sensors with a resolution of 2×2 pixels and an inventively narrow field of view (“FOV”) with sensors with a resolution of 8×4 pixels and also an inventively narrow field of view, a safe measurement distance and a safe detection are advantageously ensured, in particular when it comes to objects with small cross-section and little remission.

It has proven to be particularly advantageous to have a configuration of one pair of sensors each in the region of a left and of the right corner of the vehicle, preferably at the front side of the vehicle.

As to the terminological relationship of the terms front side, rear side, left and right, as used herein, it should be noted that a vehicle comprised by the invention may move on land or by sea in several directions of travel. In particular, a steering shaft may be installed. Further, the invention may include a tracked vehicle. Yet, the vehicle may also look identical from all sides, and in this case the front side is the “front” face pointing to the direction of travel while moving.

Preferably, the vehicle is an automatically controlled vehicle or AVG, respectively.

### SHORT DESCRIPTION OF THE DRAWINGS

The invention will be explained in more detail with reference to the drawings and the following description.

FIG. 1 shows a schematic diagram of a vehicle in the form of an AGV in top view in a first configuration of interconnection.

FIG. 2 shows a schematic diagram of a vehicle in the form of an AGV in top view in a second configuration of interconnection.

FIG. 3 shows a schematic diagram of a vehicle in the form of an AGV in top view in a third configuration of interconnection.

FIG. 4 shows a schematic diagram of a vehicle in the form of an AGV according to FIG. 1, 2 or 3 in top view, with sensors arranged next to each other and with individually indicated front horizontal sensor fields of view, i.e., with a section in parallel to the ground, each with a horizontal viewing angle range α.

FIG. 5 shows a schematic diagram of a vehicle in the form of an AGV according to FIG. 1, 2 or 3 in top view, with sensors arranged offset from each other and with individually indicated front horizontal sensor fields of view, i.e., with a section in parallel to the ground, each with a horizontal viewing angle range α.

FIG. 6 shows a schematic diagram of a vehicle in the form of an AGV according to FIG. 1, 2, 3, 4 or 5 in side view, wherein the preferably front and rear elevation angles β are illustrated at which the sensors detect and which range between 25° and 60°, and wherein the preferably front and rear vertical sensor fields of view are indicated, i.e., with a section perpendicular to the ground, each with a vertical viewing angle range α′.

FIG. 7 shows a vehicle approaching an airplane as an example use case for avoiding collision of the vehicle with the wings or the engines of the airplane.

FIG. 8 shows two vehicles driving one behind the other, wherein one or both are configured according to the invention, as an example use case for avoiding collisions and rear-impact crashes, respectively, of the vehicles.

FIG. 9 shows a vehicle detecting a relatively small in-the-air obstacle such as carrier.

### DESCRIPTION OF PREFERRED EMBODIMENTS OF THE INVENTION

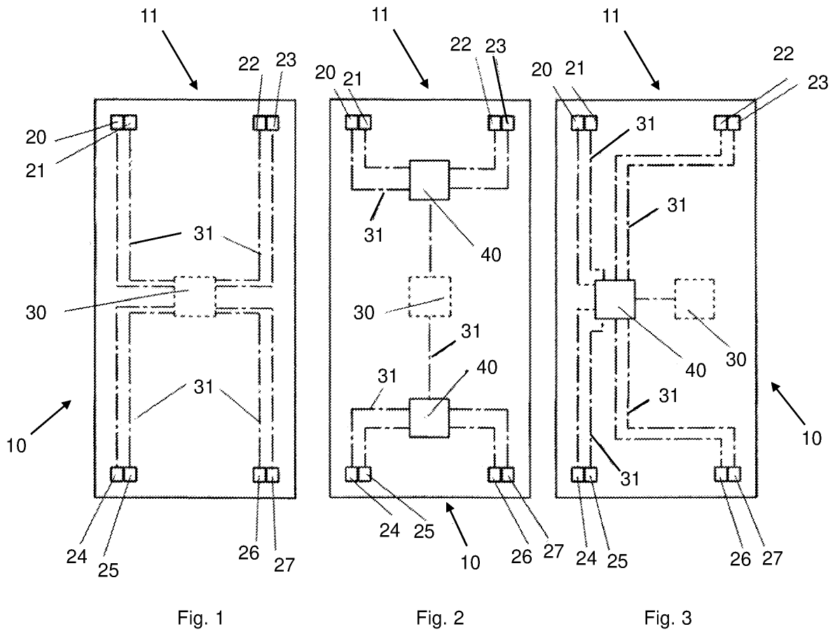

FIG. 1 shows a schematic diagram of a first exemplary embodiment of a vehicle 10 in the form of an AGV in top view. Here, in line with common linguistic usage, an AGV means a driver-less, automatically controlled and preferably lane-bound transporting vehicle with a discrete drive which can do transports autonomously and without any human intervention. Basically, the vehicle 10 may also be a different vehicle than an AGV.

In the example explained, the vehicle 10 has four optical sensor elements 20, 21, 22, 23 in the region of its front side 11 (relative to the direction of travel or the usual direction of travel) or, generally, in the region of one side of the vehicle 10, the optical sensor elements being connected to a central on-board machine control 30, serving as an evaluation and control electronics, via bus lines 31. The bus lines 31 preferably are traditional CAN bus lines which may optionally be secured as well. The signals and the distance values provided by the sensors 20, 21 and 22, 23 are evaluated by the evaluation and control electronics. When receiving prespecified signals, e.g., when falling below defined distance values, the machine control 30 reacts, e.g., by reducing the driving speed, thereafter immediately stopping the vehicle and notifying the control center.

Moreover, the vehicle 10 has additional four sensor elements 24, 25, 26, 27 in the region of its rear side or, generally, at a side opposing the side with the sensor elements 20, 21, 22, 23. Like the optical sensor elements 20, 21, 22, 23, these may also be optical sensor elements such that the vehicle may likewise drive forwards and backwards and provides for collision avoidance in both directions of travel, respectively. Basically, the additional sensor elements 24, 26, 27 may also be other sensor elements as they have already been used with AGVs for collision avoidance in the prior art.

Meanwhile, it should be noted that although not shown in the FIGS. 1 to 6 for clarity, additional collision warning units and one or more associated additional sensor elements, respectively, may be provided in addition to the shown and more fully explained optical sensor elements 20, 21, 22, 23 in the front region of the vehicle and/or sideways of the vehicle and/or in the rear region of the vehicle. In particular, in addition to the inventively provided optical sensor elements 21, 22, 23, the vehicle 10 may also comprise a sensor system according to DE 10 2018 110 852 A1, with this sensor system then preferably also interacting with the evaluation- and control electronics.

The second exemplary embodiment of FIG. 2 differs from the exemplary embodiment of FIG. 1 only with respect to the interconnection of the sensor system. In FIG. 2, the front sensor elements 20, 21, 22, 23 and the rear sensor elements 24, 25, 26, 27 are at first each connected to a sensor interface electronics 40 via bus lines 31, with the respective sensor interface electronics 40 then being connected to a centralized machine control 30 via bus lines 31. Thus, FIG. 1 shows a centralized connectivity of the sensor elements with the machine control 30, while a decentralized connectivity is implemented in FIG. 2.

The third exemplary embodiment of FIG. 3 differs from the exemplary embodiment of FIG. 1 again only with respect to the interconnection of the sensor system. In FIG. 3, the front sensor elements 20, 21, 22, 23 and the rear sensor elements 24, 25, 26, 27 are connected to a common sensor interface electronics 40 via bus lines 31, which is then connected to a centralized machine control 30 via a bus line 31. Thus, FIG. 3 shows another decentralized evaluation of the sensor signals from the front sensor elements 20, 21, 22, 23 and the rear sensor elements 24, 25, 26, 27.

In the exemplary embodiments explained, the sensor interface electronics 40 and the machine control 30 are each provided on board. Alternatively, the machine control 30 may also be positioned remotely from the vehicle 10 and be connected thereto, and communicating therewith, in particularly wirelessly.

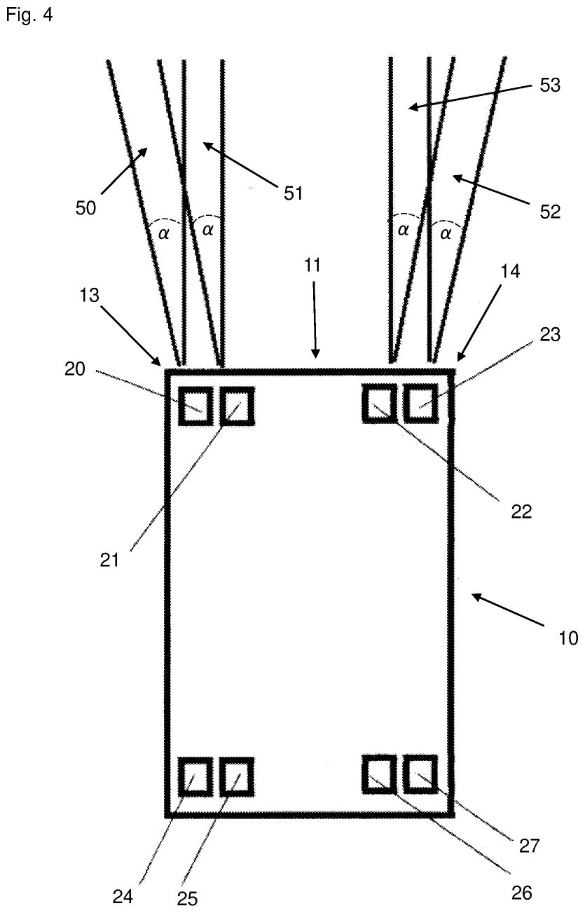

FIG. 4 shows a schematic drawing of a vehicle in the form of an AGV according to FIG. 1, 2 or 3, with fields of view (“FoV”) 50, 51, 52, 53 of the four optical sensor elements 20, 21, 22, 23 being indicated in the front region of the vehicle in horizontal section. Thus, for clarity, only the horizontal field of view is illustrated in the schematic drawing but not the vertical one. In the examples explained, the vehicle 10 is a driver-less transporting vehicle in the form of a ground-bound means of transport with discrete drive which is controlled, and led, automatically (AGV) without any human intervention.

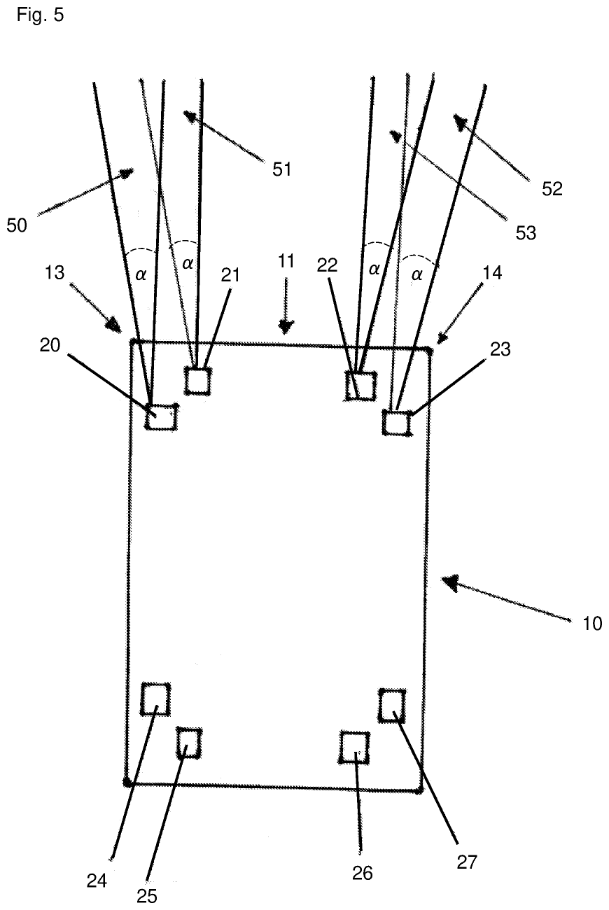

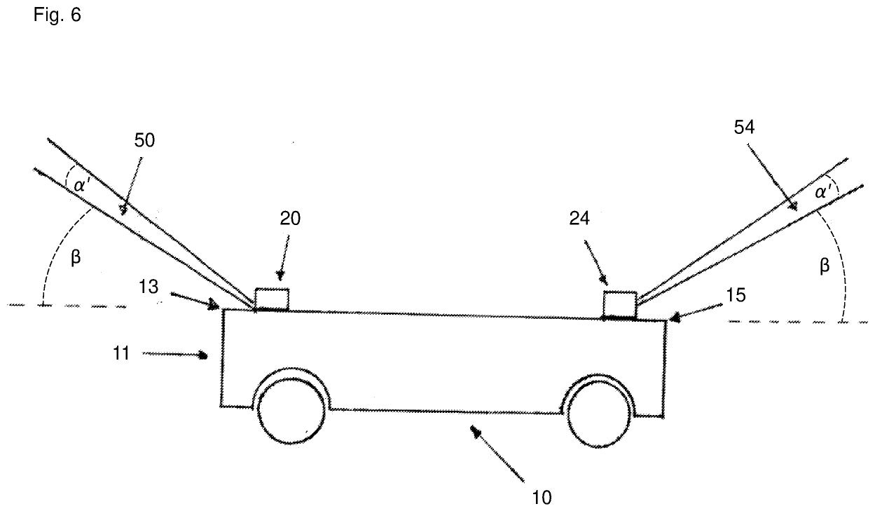

At least one of the optical sensor elements 20, 21, 22, 23, preferably all of them, has a field of view 50, 51, 52, 53 which can also be referred to as detection area or measurement field, extending horizontally and/or vertically across a viewing angle range of less than 3 degrees. Here, the horizontal viewing angle range is designated with a, compare FIG. 4 and FIG. 5, and the vertical viewing angle range is designated with a′, compare FIG. 6.

Preferably, the horizontal viewing angle range α and/or the vertical viewing angle range a′ is/are in the range of from to 1.5 degrees or from 0.5 to 1.5 degrees.

Particularly preferably, both the vertical and the horizontal viewing angle range α, a′ are less than 3 degrees, preferably in the range of from 0.1 to 1.5 degrees or from 0.5 to 1.5 degrees.

The fields of view, or detection areas, 50, 51, 52, 53 each define the detection and measurement area, respectively, of the respective optical sensors 20, 21, 22, 23 within which objects, events or changes can be sensed.

The optical sensor elements 20, 21, 22, 23 are each arranged in pairs in spatial proximity to each other to the left and to the right in the region of the left corner 13 and the right corner 14 of the vehicle 10. Preferably, the optical sensor elements 20 and 21 or 22 and 23, respectively, are each arranged next to each other or one behind the other or offset from each other. To check plausibility of the individual sensor signals or measurement values, it is advantageous to provide the sensors 20 and 21 as well as 22 and 23 each with a vertically different angle. This angle which may also be referred to as elevation angle β is preferably in the range of from 25 degrees to 60 degrees.

FIG. 6 shows a schematic diagram of a vehicle in the form of an AGV according to FIG. 1, 2, 3, 4 or 5 in side view, wherein the elevation angles β are illustrated at which the herein exemplarily shown sensors 20, 24 detect and which range between 25° and 60°, and wherein vertical sensor fields of view 50, 54, each with a vertical viewing angle range α′, are indicated. From FIG. 6 can also be gathered that the exemplarily visible sensor element 20 is preferably positioned in the front region or by the corner 13 of the vehicle 10 or, generally, in the region of a first side of the vehicle 10 and that the exemplarily visible sensor element 24 is positioned in the rear region 12 or by the corner 15 of the vehicle 10 or, generally, in the region of one side opposing the first side of the vehicle 10.

As shown in FIG. 4, the two sensor elements 20, 21, 22, 23 located in spatial proximity to each other have fields of view 50, 51, 52, 53 sideways, or laterally, offset from each other. The lateral offset preferably is in the range of from 25 mm to 120 mm.

The optical sensor elements 20, 21, 22, 23 are each selected, and adapted, respectively, in a way that the highest detection sensitivity of the two optical sensor elements 20 and 21 located in spatial proximity to each other is in each case at a different wavelength, preferably in the non-visible near infrared. The same holds for the optical sensor elements 22 and 23. Consequently, the highest sensitivity of the first optical sensor element 20 and of the third optical sensor element 22 is, e.g., at 905 nm and of the second optical sensor elements 21 and of the fourth optical sensor element 24 is, e.g., at 850 nm.

Basically, it is advantageous that the highest sensitivity of the optical sensor elements 20, 21, 22, 23 in each case is within a wavelength range of from 600 to 1100 nm.

Further, the optical sensor elements 20, 21, 22, 23 are each selected, and adapted, in a way that the two sensor elements and 21 or 22 and 23, respectively, located in spatial proximity to each other ensure a measurement distance which is as identical or similar as possible. Thus, together with the different wavelengths of the highest detection sensitivity of the optical sensor elements 20 and 22 or 21 and 23, respectively, also possible collision objects of different sizes and with different degrees of reflection are detected almost at the same time.

When the respective fields of view between the sensor elements and 21 or 22 and 23, respectively, are positioned in a different vertical orientation, it is possible for a first one of the two optical sensor elements 20, 21 or 22, 23, respectively, to detect an obstacle earlier than the second one of the two optical sensor elements 20, 21 or 23, 24, respectively. Thus, the measurement signal from one of the optical sensor elements, e.g., from the optical sensor element 20 or 22, respectively, which is reacts at first can be validated and plausibility checked, respectively, by the minimally delayed resulting measurement signals of the optical sensor elements 21 or 24, respectively, to safely avoid a possible collision and/or false alarms.

A multi-pixel resolution of the optical sensor elements 20, 21 or 23 and 24, respectively, is of particular advantage. Thereby, thanks to the movement of the AGV, an additional plausibility check is made by successive different pixels sampling a possible collision object and thus increasing detection reliability, while still ensuring detection reliability in case of a failure of the second sensor element.

Further, using different wavelength ranges or using different wavelengths of the highest detection sensitivity for the optical sensor elements 20 and 22 compared to the optical elements 21 and 24 and/or offsetting the fields of view 51 laterally and vertically from 50 or 53 from 52, respectively, serves the same purpose, namely increasing the reliability of obstacle detection and mutual validation and plausibility check, respectively, of sensor signals or measurement values.

In particular, the lateral offset allows for the validation of signals or measurement values of obstacles in the region of the corners 13, 14, 15, 16 of the vehicle since such obstacles enter into the respective fields of view 50, 51, 52, 53 at slightly different times.

Different wavelength ranges or different wavelengths of the highest detection sensitivity allow for sensor signals or measurement values to be allocated to the respective optical sensor 20, 21, 22, 23 such that a decision can already be made as to whether the reflected signal to be processed originates from the optical sensor element 20 or the optical sensor element 21, e.g. What is even more important is the finding that obstacles are not detected equally well at all wavelength ranges and under all environmental conditions (rain, sunlight, smoke, fog . . . ). Thus, to counteract this problem, sensors with different wavelength ranges or different wavelengths of the highest detection sensitivity and at the same time high insensitivity to interfering light, e.g., are used.

In summary, it is preferably provided for that the two sensor elements 20 and 21 or 22 and 23, respectively, located in spatial proximity to each other are configured, and interact with the evaluation and control electronics 30, 40, in a way that the signals or measurement values of one of the two sensor elements can be plausibility checked, or validated, by signals or the measurement values from the other of the sensor elements.

Preferably, the optical sensor elements 20, 21, 22, 23 are positioned at the corners 13 and 14 in the upper region of the vehicle 10 such that the respective field of view 50, 51, 52, 53 of the sensor elements 20, 21, 22, 23 will not be obstructed in vertical and/or horizontal direction.

Further, the sensor elements 20 and 21 as well as 22 and 23 arranged in the region of, or in proximity to, the left front corner 13 of the vehicle 10 and in the region of, or in the proximity to, the right front corner 14 of the vehicle 10 are preferably positioned and configured in a way that they each have a horizontal and/or vertical field of view 50, 51, 52, 53 which extends across an area in front of the vehicle 10 as well as in an area slightly sideways next to the vehicle, thus allowing for the surroundings of the front corners 13, 14 of the vehicle 10 to be observable not only from in front of the vehicle 10 but also from a bit sideways therefrom.

Preferably, the optical sensor elements 20, 21, 22, 23 have such a measurement distance that obstacles at a horizontal distance of from 5 m to 10 m, in particular from 3 m to 8 m, and at a height of from 4 m to 7 m can be safely detected by the vehicle 10.

The optical sensor elements 20, 21, 22, 23 each have a detection area, or sampling conus area, respectively, defined by the respective horizontal and vertical viewing angle range α, α′ and the respective measurement distance, with said areas preferably having a rectangular (e.g., with an 8×4 pixel matrix), square (e.g., with a 2×2 pixel matrix), circular or elliptical section in lateral direction towards the vehicle 10 and vertically towards the ground.

Preferably, the fields of view or measurement fields 50, 51, 52, 53 each extend at an angle of from between 25° to 60° relative to the longitudinal axis upwards and to the level of the vehicle 10 to a ground on which the vehicle 10 is moving, up to a height which corresponds at least to the height of the vehicle 10, compare FIG. 6.

Preferably, all of the optical sensor elements 20, 21, 22, 23 each have a field of view or measurement field 50, 51, 52, 53 which extends up to a height of at least 6 m or at least 7 m.

For example, laser optical distance, range and speed sensors are used as the optical sensor elements 20 and 23, preferably a measuring laser with infrared wavelengths of about 905 nm, target laser, red, 635 nm and a laser-pulse travel-time method, with the measurement area of which particularly preferably ranging between 8 to 150 m at a remission of the measurement object of from 6% to 8%.

Preferably, sensors ensuring a measurement distance of up to 10 m at a wavelength of about 940 nm are used as the optical sensor elements 21 and 22.

Advantageously, ToF sensors in connection with a vertical cavity surface emitting laser (VCSEL) transmitting module with a wavelength of 850 m can be used as the optical sensor elements 20 and 23 as well as 21 and 22. The receiving module preferably consists of an 8×4 pixel matrix. Particularly advantageously, this sensor is provided with a permanent self-monitoring using a control pixel.

Optical sensor elements 20, 21, 23, 24 with a multi-pixel resolution offer the advantage that they allow for an additional plausibility check since successive different pixels detect a possible collision object and thus ensure detection reliability even when one sensor element fails, thanks to the movement of the AGV.

To provide for an optimum detection, the measurement frequency of the optical sensor elements 20, 21, 22, 23 should be at least 100 Hz. At a duty cycle of 100%, e.g., an encoded signal is preferably used which is pulsed at a predetermined frequency to be detected by the receiver as useful signal. Such an encoded signal is also used to suppress the influence of interfering light.

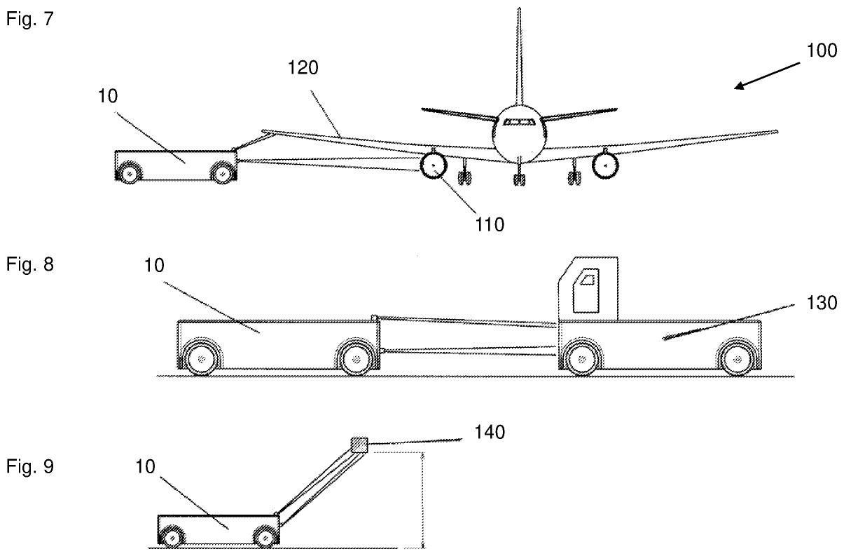

FIG. 7 shows a vehicle 10 approaching an airplane 100 as an example use case of the invention. Here, the aim is to avoid a collision with the wings 120 and/or the engines 110 of the airplane 100. Advantageously, this use also allows for contours detection to be realized by means of the provided sensor elements 20, 21, 22, 23 and their configuration such that it can be detected, and distinguished, respectively, whether the vehicle 10 is approaching the wing 120 or the engine 110.

FIG. 8 shows two vehicles 10, 130 driving one behind the other, wherein at least the vehicle 10 is configured inventively. Preferably, both vehicles 10, 130 are configured inventively such that both detect when they are approaching each other, thus avoiding collision or rear impacts. This use is particularly important since AGVs usually have short braking distances and may stop suddenly, thus easily causing a rear-impact collision with a trailing vehicle. This is prevented here.

FIG. 9 shows a vehicle 10 detecting a relatively small in-the-air obstacle in the form of a carrier 140 as a typical use case of the invention. Here, the detection area, or sampling conus area, respectively, of the vehicle 10 resembles a “light saber”.

### LIST OF REFERENCE SIGNS

10 Vehicle, AGV, robot vehicle
11 Front side
12 Rear region
13 Front left corner
14 Front right corner
15 Rear left corner
16 Rear right corner
20 First optical sensor element
21 Second optical sensor element
22 Third optical sensor element
23 Fourth optical sensor element
24 Fifth sensor element
25 Sixth sensor element
26 Seventh sensor element
27 Eighth sensor element
30 Machine control/control electronics
31 Bus lines
40 Sensor interface/evaluation electronics
50 First field of view
51 Second field of view
52 Third field of view
53 Fourth field of view
54 Fifth field of view
100 Airplane
110 Engine
120 Wing
130 Another vehicle
140 Obstacle/carrier

1. A vehicle having one or more optical sensor elements (20, 21, 22, 23) in the region of a first side of said vehicle (10), in particular of its front side (11), which, in interaction with an evaluation and control electronics (30, 40) provided on board or positioned fully or partly remotely to said vehicle (10), is/are configured to warn about a collision of said driving vehicle (10) with an obstacle, to avoid the obstacle or the stop said vehicle (10) when detecting an obstacle, characterized in that at least one, several or all of said optical sensor elements (20, 21, 22, 23) has/have a field of view (50, 51, 52, 53) with a horizontal and/or vertical viewing angle range (a, a′) of less than 3 degrees.

2. The vehicle according to claim 1, wherein said vehicle (10) is a driver-less vehicle with a discrete drive which is controlled automatically without any human intervention.

3. The vehicle according to claim 1, wherein said at least one optical sensor element (20, 21, 22, 23) or said several or all of said optical sensor elements (20, 21, 22, 23) has/have a field of view (50, 51, 52, 53) with a horizontal and/or vertical viewing angle range (α, α′) in the range of from 0.1 to 1.5 degrees, in particular from 0.5 degrees to 1.5 degrees.

4. The vehicle according to claim 1, wherein said vehicle (10) in the region of said first side or said front side (11) has at least two of said optical elements (20, 21, 22, 23) with a field of view (50, 51, 52, 53) with a horizontal and/or vertical viewing angle range (α, α′) of less than 3 degrees, in particular from 0.1 degrees to 1.5 degrees or from 0.5 degrees to 1.5 degrees, located in spatial proximity to each other, in particular next to each, above each other or one behind the other.

5. The vehicle according to claim 1, wherein said vehicle (10) in the region of said first side or said front side (11) has at least four of said optical elements (20, 21, 22, 23) with a field of view (50, 51, 52, 53) with a horizontal and/or vertical viewing angle range (α, α′) of less than 3 degrees, in particular from 0.1 degrees to 1.5 degrees or from 0.5 degrees to 1.5 degrees, at least two of which being located in spatial proximity to each other, in particular next to each, above each other or one behind the other, and wherein a first pair (20, 21) of said optical sensor element is positioned in the region of, or in proximity to, said left, in particular said front, corner (13) of said vehicle (10), and wherein a second pair (22, 23) of said sensor elements is positioned in the region of, or in proximity to, said right, in particular said front, corner (14) of said vehicle (10).

6. The vehicle according to claim 1, wherein said two sensor elements (20, 21, 22, 23) located in spatial proximity to each other have fields of view (50, 51, 52, 53) laterally and/or vertically offset from each other.

7. The vehicle according to claim 1, wherein the maximum receiving sensitivity of said two sensor elements (20, 21, 22, 23) located in spatial proximity to each other is at a different wavelength, in particular in a wavelength range of from 600 nm to 1100 nm.

8. The vehicle according to claim 1, wherein said two sensor elements (20, 21, 22, 23) located in spatial proximity to each other have fields of view (50, 51, 52, 53) extending at different elevation angles (13) relative to the level of said vehicle (10) such that a first one of said two sensor elements can detect an obstacle earlier than said second one of said two sensor elements.

9. The vehicle according to claim 1, wherein said two sensor elements (20, 21, 22, 23) located in spatial proximity to each other are configured, and interact with said evaluation and control electronics (30, 40), in a way that said signal of one of said two sensor elements can be plausibility checked, or validated, by the signal from said other one of said sensor elements.

10. The vehicle according to claim 1, wherein said two sensor elements (20, 21, 22, 23) located in spatial proximity to each other are positioned on said vehicle (10) at a height of from 0.5 to 1.5 m above road level.

11. The vehicle according to claim 1, wherein said sensor elements (20, 21, 22, 23) arranged in the region of, or in proximity to, said left, in particular said front, corner (13) of said vehicle (10) and in the region of, or in the proximity to, said right, in particular said front, corner (14) of said vehicle (10) are positioned and configured in a way that they each have a field of view which extends across an area in front of said vehicle and optionally also in an area sideways next to said vehicle, thus allowing for the surroundings of said front corners (13, 14) of said vehicle (10) to be observable.

12. The vehicle according to claim 1, wherein said at least one optical sensor element (20, 21, 22, 23) has such a detection distance that obstacles at a distance of from 3 m to 10 m, in particular from 3 m to 7 m, in the front of said vehicle (10) can be reliably detected.

13. The vehicle according to claim 1, wherein said at least one optical sensor element (20, 21, 22, 23), said several or all of said optical sensor elements (20, 21, 22, 23) has/have a receiving module in the form of a pixel matrix, in particular in the form of an 8×4 pixel matrix or a 2×2 pixel matrix.

14. The vehicle according to claim 1, wherein, in addition to said at least one optical sensor element (20, 21, 22, 23), one or more additional sensor elements (24, 25, 26, 27) is/are provided which, in interaction with said evaluation and control electronics (30, 40), is/are configured to warn about a collision of said driving vehicle (10) with an obstacle, to avoid the obstacle or to stop said vehicle (10), wherein said one or more additional sensor elements (24, 25, 26, 27) is/are arranged at said first side or said front side of said vehicle (10) and/or sideways and/or at said rear side of said vehicle (10).

15. A method for avoiding collision of a vehicle (10) with an obstacle, wherein one or more optical sensor elements (20, 21, 22, 23) are arranged in the region of said front side (11) of said vehicle (10) having a field of view (50, 51, 52, 53) with a horizontal and/or vertical viewing angle range (a, a′) of less than 3 degrees, and wherein it is provided for that said one optical sensor element or said more optical sensor elements (20, 21, 22, 23), in interaction with an evaluation and control electronics (30, 40) provided on board or positioned fully or partly remotely to said vehicle (10), warns/warn about a collision of said driving vehicle (10) with an obstacle, avoids/avoid the obstacle or stops/stop said vehicle (10) when an obstacle is being detected.

16. The method according to claim 15, wherein said vehicle (10) is a vehicle.
